(19) United States
(12) Patent Application Publication
(10) Pub. No.: US 2025/0375730 A1
(43) Pub. Date: Dec. 11, 2025

(54) MEMBRANE VOLATILE COMPOUND CAPTURE IN POST-COMBUSTION CARBON CAPTURE

(71) Applicant: Entropy Inc., Calgary (CA)

(72) Inventors: Paitoon TONTIWACHWUTHIKUL, Regina (CA); Raphael IDEM, Regina (CA); Tianci LI, Regina (CA); Congning YANG, Regina (CA); Gui TREMBLAY, Toronto (CA); James MARTIN, Calgary (CA); Megan BORDEN, Calgary (CA)

(73) Assignee: Entropy Inc., Calgary, AB (CA)

(21) Appl. No.: 19/230,382

(22) Filed: Jun. 6, 2025

(30) Foreign Application Priority Data
Jun. 7, 2024 (CA) 3241187

(51) Int. Cl. B01D 53/14; B01D 61/02; C02F 1/44; C02F 101/32; C02F 103/18

(52) U.S. Cl. CPC B01D 53/1475; B01D 61/025; C02F 1/441; B01D 2257/504; C02F 2101/322; C02F 2103/18; C02F 2209/02

(57) ABSTRACT

Apparatus and methods to a prepare and use such apparatus for the capture of a volatile compound component from a water wash solution in an absorption unit of a post-combustion carbon capture system, said apparatus located after a water wash section of said unit where said water wash solution, comprising said volatile compound component, is exposed to said apparatus comprising a means to separate a volatile compound component from said water wash solution.

### CROSS-REFERENCE TO RELATED APPLICATIONS

This application claims priority under 35 U.S.C. § 119 to Canadian Patent Application No. 3,241,187, filed Jun. 7, 2024, in the Canadian Intellectual Property Office, the disclosure of which is incorporated by reference herein in its entirety.

### FIELD OF INVENTION

The present disclosure relates generally to methods and systems for volatile compound capture in the water wash section of post-combustion carbon capture processes.

### BACKGROUND OF THE INVENTION

Post-combustion CO₂ capture (PCCC) is a mature technology, which aims to separate CO₂ from a flue gas stream released from industrial processes. PCCC is currently the most promising and mature strategy for CO₂ capture from industrial processes and can be either retrofitted into existing traditional large-scale fossil fuel-fired power plants or built as end-of-pipe removal technology for new plants.

Chemical absorption of CO₂ is a typical process in PCCC by using chemical solvents that are compatible with the composition of the flue gas stream and heats and pressures involved in the particular PCCC process. The principle of chemical absorption involves a reversible chemical reaction of CO₂ with a chemical solvent in an absorption column, which can form a strong chemical bond between the solvent and the CO₂. Then the chemical bond is broken to release the captured CO₂ upon exposure to high temperature (˜120° C.) in a stripper column (or desorber column, or regenerator), and the regenerated lean amine solvent solution can be circulated back through the system for another absorption process.

The types of potentially usable chemical solvents are diverse, such as: aqueous amine solvents, ionic liquids, non-aqueous amine solvents, ionic liquids with amine solvents, and others. Amine solvents are widely considered to be favourable for use in PCCC processes, due to their comparably low price. Certain amine solvents with great absorption kinetics in the absorption process are volatile and would quickly evaporate and be lost in the process, resulting in efficiency lost in both the absorption and desorption portions of the PCCC process. A common technique for capturing the vaporized amine is called a water wash process, wherein water is applied to absorb the vaporized amine from the treated gas, resulting in cleaner treated gas.

Disposing of the used water from the water wash as waste may increase expenses associated with the solvent, which is not an economically viable solution for the operator. Therefore, there is a need to develop a novel processing step in a PCCC process to capture evaporated volatile amine solvent from the waste streams, reintroduce the water and aqueous amine solvent into the water wash section, and replenish the make-up solvent tank of the PCCC process, respectively.

### SUMMARY OF THE INVENTION

According to one aspect of the present invention, there is provided a process to capture a volatile compound which is integrated in a PCCC process. Preferably, said process uses a membrane system for capturing evaporated volatile compound, as part of a water wash step, and reintroducing: such captured evaporated solvent back into the remaining aqueous amine solvent circulating through the system of a PCCC process; and, the recovered water back into a water wash column of the water wash step.

According to one aspect of the present invention, there is provided an apparatus for the capture of a volatile compound component from a water wash solution in an absorption unit of a post-combustion carbon capture system, said apparatus located after a water wash section of said unit where said water wash solution, comprising said volatile compound component, is exposed to said apparatus comprising a means to separate a volatile compound component from said water wash solution.

According to a preferred embodiment of the present invention, said means to separate a volatile compound component from said water wash solution comprises at least one membrane system.

According to a preferred embodiment of the present invention, said at least one membrane system comprises one or more reverse osmosis membrane columns.

As used herein, the term “volatile compound” refers to a volatile organic compound.

According to one aspect of the present invention, there is provided a method to treat and capture a volatile compound component from a water wash solution in a water wash portion of a post-combustion carbon capture system, wherein said method comprises the steps of:
(a) providing a means to separate a volatile compound component from a water wash solution;
(b) providing said water wash solution;
(c) exposing said water wash solution to said means to separate a volatile compound component therefrom; and
(d) recovering a treated water wash solution.
(e) reusing treated water

According to a preferred embodiment of the present invention, the treated water wash solution is water that is substantially free of, or contains a lower concentration of, volatile compound components.

According to a preferred embodiment of the present invention, said means to separate a volatile compound component from said water wash solution comprises at least one membrane system.

According to a preferred embodiment of the present invention, said at least one membrane comprises one or more reverse osmosis membrane columns.

According to a preferred embodiment of the present invention, said water wash solution comprises one or more of the following compounds: 2-1-(2-hydroxyethyl) pyrrolidine (PR), hexamethylenediamine (HMDA), polyethylenimine (PEI, branch), 2-diethylaminoethanol (DEAE), 4-Amino-1-butanol (E), and monoethanolamine (MEA).

According to a preferred embodiment of the present invention, an initial concentration of said volatile compound component in said water wash solution is in the range of 0.01M to 0.5M;

According to a preferred embodiment of the present invention, a preferred temperature of said water wash solution is in the range of 25° C. to 40° C.;

According to one aspect of the present invention, there is provided a use of an apparatus comprising a means to separate and capture a volatile compound contaminant from a water wash solution in a water wash portion of a post-combustion carbon capture system.

According to a preferred embodiment of the present invention, said volatile compound contaminant comprises one or more of the following compounds: 2-1-(2-hydroxyethyl) pyrrolidine (PR), hexamethylenediamine (HMDA), polyethylenimine (PEI, branch), 2-diethylaminoethanol (DEAE), 4-Amino-1-butanol (E), and monoethanolamine (MEA).

According to a preferred embodiment of the present invention, said initial concentration of said volatile compound contaminant in said water wash solution is in the range of 0.01M to 0.5M.

According to one aspect of the present invention, there is provided a process to capture volatile compound which is integrated in a PCCC process. Preferably, said process uses a membrane system for capturing evaporated volatile compound, as part of a water wash step, and reintroducing: such captured evaporated solvent back into the remaining aqueous amine solvent circulating through the system of a PCCC process; and, the recovered water back into a water wash column of the water wash step.

According to one aspect of the present invention, there is provided an apparatus for the capture of a volatile compound from an aqueous amine solvent in an absorption unit of a post-combustion carbon capture system, said apparatus located after a water wash section of said unit where said aqueous amine solvent, comprising said volatile compound and a contaminant, is exposed to said apparatus comprising a means to separate a contaminant from said volatile compound.

According to a preferred embodiment of the present invention, said means to separate said volatile compound from water comprises at least one membrane.

According to a preferred embodiment of the present invention, said at least one membrane comprises a reverse osmosis membrane.

According to one aspect of the present invention, there is provided a method to treat and capture an evaporated volatile compound in a water wash portion of a post-combustion carbon capture system, wherein said method comprises the steps of:
(a) providing means to separate a contaminant from a volatile compound;
(b) providing a contaminated volatile compound;
(c) exposing said contaminated volatile compound to said means to separate said contaminant from said volatile compound; and
(d) recovering a treated volatile compound.
(e) reusing treated volatile compounds.

According to a preferred embodiment of the present invention, said contaminant is water.

According to a preferred embodiment of the present invention, said treated volatile compounds are the concentrated volatile compound components in water.

Preferably, the process has one or more of the following desirable properties for the capture of volatile compounds from waste liquids: high separation efficiency, initial solvent concentrations in the range of 0.01M to 0.5M, operating temperatures in the range of 25° C. to 40° C., operating pressures in the range of 0.5 MPa to 1.5 MPa, and flow rates in the range of 4 L/min-14 L/min. Such a process would allow the use of volatile amine solvents in PCCC processes and, therefore, allow PCCC to be viable for use with volatile amine solvents, which it currently is not.

According to a preferred embodiment of the present invention, an initial concentration of said volatile compound in said contaminated volatile compound is in the range of 0.01M to 0.5M;

According to a preferred embodiment of the present invention, a temperature of said contaminated volatile compound is in the range of 25° C. to 40° C.;

According to a preferred embodiment of the present invention, an operating pressure of said contaminated volatile compound is in the range of 0.5 MPa to 1.5 MPa;

According to a preferred embodiment of the present invention, a flow rate of said contaminated volatile compound if in the range of 4 L/min-14 L/min;

According to one aspect of the present invention, there is provided a use of an apparatus comprising a means to separate and capture a volatile compound contaminated with a contaminant, in a solvent regeneration portion of a post-combustion carbon capture system.

### BRIEF DESCRIPTION OF THE DRAWINGS

Features and advantages of the embodiments of the present invention will become apparent from the following detailed description, taken in combination with the appended drawings in which:

FIG. 1 is a process diagram of a conventional PCCC plant system, including an absorption unit where CO₂ is removed from a gas phase into a liquid amine solvent with at least one volatile compound and the treated gas with vaporized amine passes through a water wash unit and the used water from said water wash unit flows to an amine recovery apparatus comprising at least one membrane, which recovers a concentrate stream comprising said vaporized amine and a filtrate stream comprising mainly water;

FIG. 2 is a schematic drawing illustrating a bench-scale experimental set-up used to measure separation efficiency of the membrane system under different temperature and operational pressure conditions and with various chemical amine solvent components and initial solvent concentrations and concentration ratios (being the flow rate ratio of concentrate stream to the filtrate stream), wherein the initial solvent concentration of the aqueous amine solvent is varied to mimic the actual amine concentration in the water wash solution;

FIG. 3 is a graphical representation of the separation efficiency of the system for MEA and DEAE solvents with varied initial concentrations, produced by an experiment performed by the inventors using the set-up shown in FIG. 2;

FIG. 4 is a graphical representation of the separation efficiency profile of DEAE solvents with varied initial concentrations, produced by an experiment performed by the inventors using the set-up shown in FIG. 2;

FIG. 5 is a graphical representation of the reduction of the separation efficiency of the system resulting from increasing the concentration ratio of a DEAE solvent, produced by an experiment performed by the inventors using the set-up shown in FIG. 2; and

FIG. 6 is a graphical representation of the separation efficiency of the system for MEA and DEAE solvents by varying the high-pressure condition from 0.6 to 1.3 MPa, produced by an experiment performed by the inventors using the set-up shown in FIG. 2.

### DETAILED DESCRIPTION

The description which follows, and the embodiments described therein, are provided by way of illustration of an example or examples of particular embodiments of the principles of the present invention. In the following description of the invention, numerous examples are provided and specific details are set forth for the purposes of explanation and not limitation in order to provide a thorough understanding of the invention. The person skilled in the art will readily appreciate that the well-known methods, procedures and/or components will not be described as to focus on the invention in question. Accordingly, in some instances, certain structures and techniques have not been described or shown in detail in order not to obscure the invention.

Hereinafter, a preferred apparatus for the capture of an evaporated volatile compound in a water wash portion of a post-combustion carbon capture system will be described. Preferably, said apparatus is a membrane system for the capture of evaporated volatile compound and reintroduction of such volatile compound to an amine solvent stream according to the present disclosure.

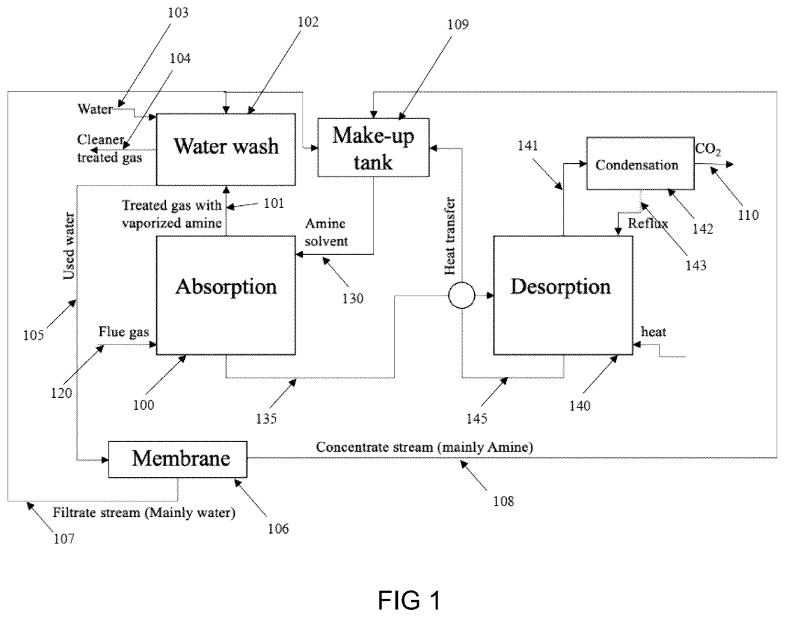

A conventional PCCC plant system generally consists of two sections, as shown in the FIG. 1 process diagram: an absorption unit 100, where CO₂ 110 is removed from a gas phase (the flue gas from a fossil fuel combustion unit) 120 into a liquid solvent, which is an aqueous amine solution 130; and a solvent regeneration or desorption unit 140 where the used, CO₂-loaded rich solvent 135 is recovered before being recycled back to the absorption unit 100. In the desorption unit 140 the CO₂ 110 is desorbed and separated from the CO₂-rich aqueous amine solution 135 and the resulting CO₂-lean aqueous amine solution 145 is sent back into the absorption unit.

In the desorption process, CO₂ 141 is separated from the CO₂-rich solvent 135, through a condensation process 142. Vaporized amine and water 143 will be separated and returned to the desorption unit 140 to avoid water 143 and amine loss, while a cleaner stream of CO₂ 110 is formed. Due to the unique volatility of amine solvent and the secondary pollution caused by its volatile substances entering the atmosphere, the treated gas 101 also known as sweet gas, is sent to a water wash tower 102. Based on the principle that amine substances dissolve in water 103, amine substances can be removed from the treated gas 101 to form cleaner treated gas 104. The innovation in the present invention lies in the on-site amine treatment of used wastewater 105 and the repeated use of the amine solution 108 and filtrate 107. Specifically, the wastewater 105 is sent to a membrane treatment unit 106, and the filtrate 107 and concentrate 108 are separately sent to a water wash tower 102 and a make-up tank 109, respectively. Recycling is achieved based on the flow ratio and the final output concentration.

Certain amine solvents with desirable absorption kinetics profiles in the absorption process are volatile and would quickly evaporate and be lost in the carbon capture process, resulting in lost efficiency in both absorption and desorption units. To prevent the release of vaporized amine into the atmosphere, operators typically use water to wash the treated gas stream, known as a water wash unit. The utilized water serves to absorb the volatile compound, forming what is known as a water wash solution. While this method effectively reduces secondary pollution caused by a volatile amine, it does not prevent amine loss in the carbon capture process.

It has heretofore been discovered that the integration of a membrane in treating waste liquid streams containing a volatile amine solvent provides an advantage as it reduces the amount (or volume) of said volatile amine solvent lost in processing. The recovered amine solvent and water have great potential for reuse in a PCCC process in different operating units. In the absorption unit, the reaction of an amine solvent and CO₂ is exothermic, resulting in significant amine solvent loss. When amine solvent loss occurs, CO₂ capture efficiency drops and energy demand increases. A PCCC process is likely to be rendered not economically viable due to a loss of volatile amine solvent in the absorption unit. This also limits the implementation of carbon capture plants and the like.

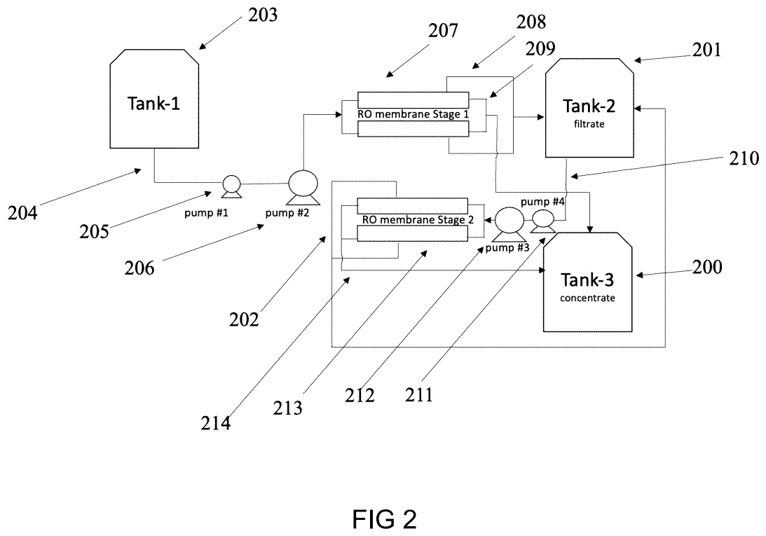

FIG. 2 is a schematic drawing illustrating a bench-scale experimental set-up according to a preferred embodiment of the apparatus according to the present invention. The set-up is used to measure separation efficiency of the membrane system under different temperature and operational pressure conditions and with various chemical amine solvent components and initial solvent concentrations and concentration ratios (being the flow rate ratio of concentrate stream to the filtrate stream). The system consists of two-stages of operation. The concentration ratio affects the separation efficiency of the system. The initial concentration of the aqueous amine solvent is varied to mimic the actual amine concentration of water wash solution. The filtrate is the liquid solution with a lower amine concentration; thus, a lower amine concentration in the filtrate indicates better separation efficiency. Amine concentration was experimentally assessed using an acid-base titration apparatus.

Tank-1 203 is a storage tank for the stoste solution, referred to as the initial solvent, which mimics the composition of a water wash solution containing water and amine compounds. The liquid stream 204 flows to Pump #1 205, which delivers a stable flow rate. Pump #2 206 is a high-pressure pump that provides the necessary pressure conditions for reverse osmosis RO operation.

The liquid then enters the first-stage RO membrane units 207, which consist of multiple RO membrane columns. Stream 204 can be distributed among these columns depending on the total flow rate. The outlets are split into two streams: filtrate 208 and concentrate 209. The filtrate primarily contains water with a small amount of amine, whereas the concentrate has a higher amine concentration and lower water content. The filtrate stream 208 is directed to the filtrate tank (Tank-2, 201), while the concentrate stream 209 is sent to the concentrate tank (Tank-3, 200).

To increase concentrate production, a second-stage RO membrane unit 213 is employed. The filtrate stream 210 from the first stage is pumped to the second-stage membrane columns 213 via a flow pump 211 and a high-pressure pump 212. As in the first stage, Pump #4 ensures a stable flow rate, and Pump #3 provides the required pressure for RO operation. The filtrate stream 202 is again directed to the filtrate tank (Tank-2, 201), and the concentrate stream 214 is sent to the concentrate tank (Tank-3, 200).

If the two-stage operation is insufficient, the membrane columns 213 can be reused in a recirculating RO mode. The operating procedure will remain the same as that of the second-stage operation, keep introducing filtrate liquid 210 into the membrane columns 213.

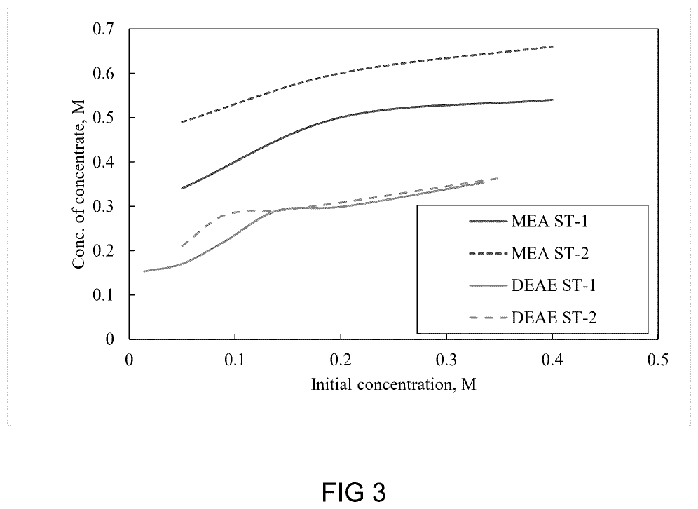

The comparison plot in FIG. 3 illustrates the separation efficiency using exactly the same operational methods for two types of amine with different initial concentrations. The initial concentration represents the inlet condition of the amine solution in original solution tank (Tank-1) 203 in FIG. 2. When using the MEA solvent, the concentration ratio can be maintained consistently at 15% for trials with different initial amine concentrations. The best separation performance was observed when the initial solvent concentration was lower than 0.2M.

Using the same operational method, when the concentration of DEAE in the initial amine solutions exceeded 0.15M, the filtrate flow rate reduced rapidly. An initial amine solution concentration exceeding 0.2M, results in a slight reduction in concentrate, due to insufficient pressure in the system because of DEAE greater viscosity than MEA. Increasing the high pressure condition is therefore necessary for effective separation using DEAE at higher concentrations.

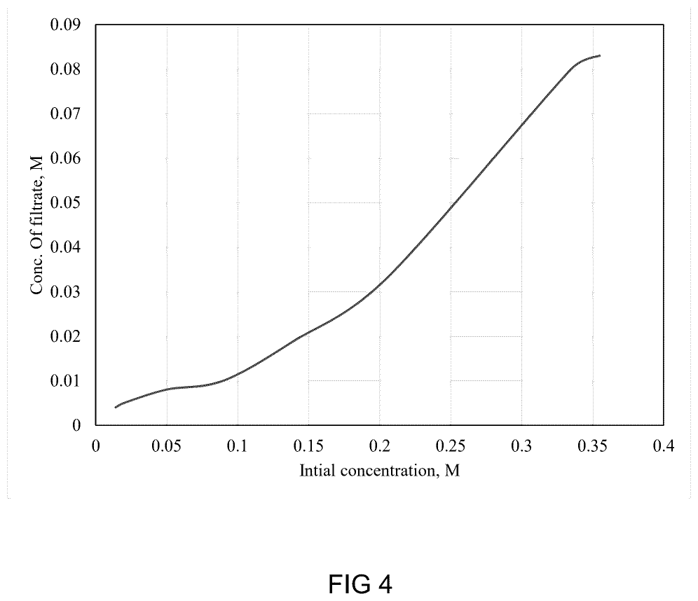

FIG. 4 illustrates the DEAE concentration profile in the filtrate stream. Three slopes are noticeable, flattest slope (initial DEAE concentration lower than 0.1M), medium slope (initial DEAE concentration between 0.1 to 0.2M), and the steepest slope (initial DEAE concentration higher than 0.2M). A steeper slope corresponds to lower separation efficiency, as higher DEAE concentration in the filtrate stream indicates lower separation efficiency, aligning with the profile depicted in FIG. 4.

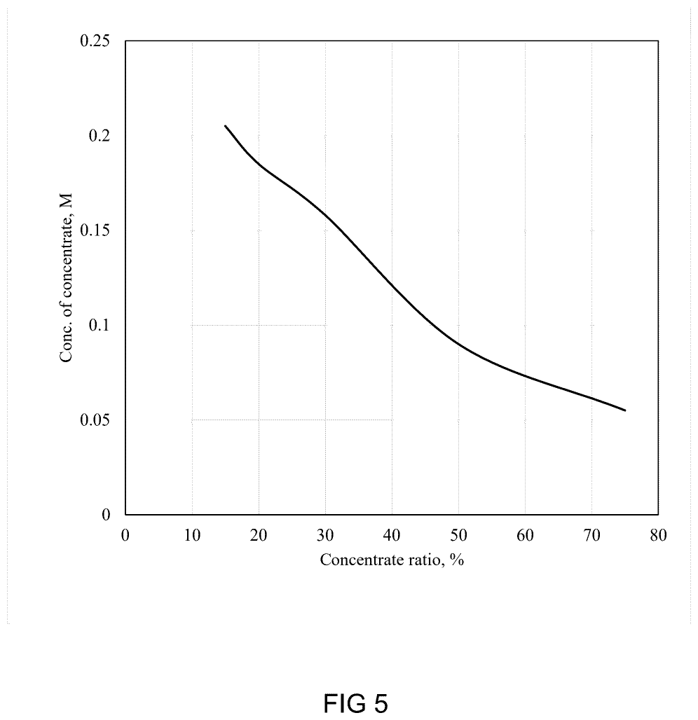

FIG. 5 illustrates the impact of concentration ratio on the DEAE separation efficiency. Using an initial concentration of 0.05M DEAE, the separation efficiency nearly linearly reduced as the concentration ratio increased. Using a concentration of 0.05M DEAE eliminated pressure issues during the experiment, which allowed the concentration ratio to be easily adjusted. The results illustrate a lower concentration ratio offers better separation efficiency. Very low concentration ratios may cause efficiency loss and energy loss. Therefore, 15-30% concentration ratio is a preferred range for the system.

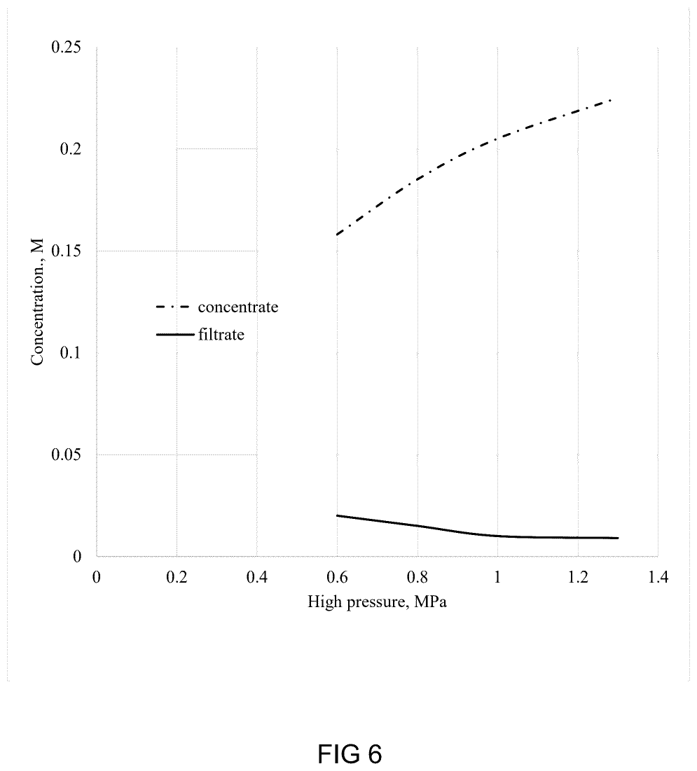

FIG. 6 illustrates a comparison of separation efficiencies by varying the high-pressure condition from 0.6 to 1.3 MPa. As the high-pressure condition increases, the total flow rate is impacted. With a consistent concentration ratio, a higher-pressure condition provides better separation efficiency.

Table 1 illustrates the effects of temperature of the initial solution on separation efficiency and flow rate in the filtrate stream, since the physical properties (such as density and viscosity) of a solvent can be affected by the temperature.

TABLE 1
Operational results at increasing temperatures of the initial solution

| | Lower conc. (M) | Higher Conc. (M) |
|---|---|---|
| Original solution (initial | 0.28 | 0.42 |
| concentration) | | |
| Filtrate (20.6° C.) | 0.14 | 0.15 |
| Concentrate (20.6° C.) | 0.3 | 0.44 |
| initial concentration (29.6° C.) | 0.31 | 0.42 |
| Filtrate (29.6° C.) | 0.13 | 0.14 |
| Concentrate (29.6° C.) | 0.33 | 0.44 |
| initial concentration (34.9° C.) | 0.29 | 0.43 |
| Filtrate (34.9° C.) | 0.12 | 0.13 |
| Concentrate (34.9° C.) | 0.33 | 0.46 |

Temperature is the average temperature calculated from the starting and finishing temperatures:

$$\#1 {T}_{a v g} = ( {T}_{start} + {T}_{f i n i s h} ) / 2 = ( 29.1 + 30 \text{.2} ) / 2 = 29.6 ° C .$$

$$\# 2 {T}_{a v g} = ( {T}_{start} + {T}_{f i n i s h} ) / 2 = ( 34.5 + 35 \text{.4} ) / 2 = 34.9 ° C .$$

According to a preferred embodiment of the present invention, the amine concentration in a filtrate stream can be purified to as low as 0.001M. This concentration is suitable for reuse of the (water) filtrate stream in the water wash system of a PCCC process. The present invention shows greater performance in purifying lower amine concentration solutions. To increase the volume of filtrate generation, it is preferable to include additional stages to continuously purify the concentrate (recovered volatile amine solvent) solutions. The efficiency of separation will be reduced when the inlet stream contains a higher initial concentration of volatile amine solvent. In preferred embodiments of the present invention, with optimal operating conditions, the filtrate can be returned to a water wash system of a PCCC process with a minimal amount, or no, additional fresh water, and the concentrate can be sent to other units of the PCCC process, such as an amine make-up tank.

Table 2 illustrates the impact of pressure on RO membrane performance for water wash solutions containing different volatile components. It is evident that pressure plays a key role in RO membrane operation. The concentrate stream in this context refers to the treated volatile component stream, which contains a higher concentration of organic compounds. In this table, ‘organic’ refers specifically to the amines MEA and DEAE. Higher inlet pressure clearly provides better separation efficiency, consequently producing a cleaner filtrate stream. The filtrate stream is the treated water that contains a lower concentration of organic components.

TABLE 2
Impact of Pressure on RO Membrane Performance
for Different Volatile Components

| Regular pressure experiment | | | | | Higher pressure experiment | | | | |
|---|---|---|---|---|---|---|---|---|---|
| Initial MEA concentration 0.3 wt. % | | | | | Initial DEAE concentration 0.5 wt. % | | | | |
| | MEA | | MEA | | | DEAE | | DEAE | |
| Pressure | concentration | | concentration | | Pressure | concentration | | concentration | |
| inlet, | in concentrate | | in filtrate | | inlet, | in concentrate | | in filtrate | |
| MPa | stream | | stream | | MPa | stream | | stream | |
| 0.6 | 0.948 | wt. % | 0.12 | wt. % | 3.3 | 7.1 | wt. % | 0.16 | wt. % |
| 0.8 | 1.11 | wt. % | 0.09 | wt. % | 3.6 | 8.1 | wt. % | 0.14 | wt. % |
| 1 | 1.23 | wt. % | 0.06 | wt. % | 3.9 | 9.5 | wt. % | 0.12 | wt. % |
| 1.3 | 1.35 | wt. % | 0.054 | wt. % | 4 | 11.4 | wt. % | 0.1 | wt. % |
| 1.6 | 3.12 | wt. % | 0.048 | wt. % | 4.3 | 14.3 | wt. % | 0.09 | wt. % |
| 1.9 | 4.74 | wt. % | 0.042 | wt. % | 4.4 | 19 | wt. % | 0.08 | wt. % |

The examples and corresponding diagrams used herein are for illustrative purposes only. The principles discussed herein with reference to membrane systems or apparatuses can be implemented in other systems and apparatuses. Different configurations and terminology can be used without departing from the principles expressed herein. For instance, steps, equipment, components, and modules can be added, deleted, modified, or re-arranged without departing from these principles.

Unless the context clearly requires otherwise, throughout the description and the claims: “comprise,” “comprising,” and the like are to be construed in an inclusive sense, as opposed to an exclusive or exhaustive sense; that is to say, in the sense of “including, but not limited to”. “Herein,” “above,” “below,” and words of similar import, when used to describe this specification shall refer to this specification as a whole and not to any particular portions of this specification. “Or” in reference to a list of two or more items, covers all of the following interpretations of the word: any of the items in the list, all of the items in the list, and any combination of the items in the list. The singular forms “a”, “an”, and “the” also include the meaning of any appropriate plural forms.

Where a component is referred to above, unless otherwise indicated, reference to that component should be interpreted as including as equivalents of that component, any component which performs the function of the described component (i.e., that is functionally equivalent), including components which are not structurally or compositionally equivalent to the disclosed structure or composition which performs the function in the illustrated exemplary implementations of the invention.

Specific examples of compositions, systems, methods and apparatuses have been described herein for purposes of illustration. These are only examples. Many alterations, modifications, additions, omissions and permutations are possible within the practice of this invention. This invention includes variations on described compositions that would be apparent to the skilled addressee, including variations obtained by: replacing features, elements and/or chemical compounds with equivalent features, elements and/or chemical compounds; mixing and matching of features, elements and/or chemical compounds from different examples; combining features, elements and/or chemical compounds from examples as described herein with features, elements and/or chemical compounds of other technology; omitting and/or combining features, elements and/or chemical compounds from described examples.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples, but should be given the broadest interpretation consistent with the description as a whole.

1. An apparatus for the capture of a volatile compound component from a water wash solution in an absorption unit of a post-combustion carbon capture system, said apparatus located after a water wash section of said unit where said water wash solution, comprising said volatile compound component, is exposed to said apparatus comprising a means to separate a volatile compound component from said water wash solution.

2. The apparatus according to claim 1, wherein said means to separate a volatile compound component from said water wash solution comprises at least one membrane.

3. The apparatus according to claim 0, wherein said at least one membrane comprises a reverse osmosis membrane.

4. A method to treat and capture a volatile compound component from a water wash solution in a water wash portion of a post-combustion carbon capture system, wherein said method comprises the steps of:
(a) providing a means to separate a volatile compound component from a water wash solution;
(b) providing said water wash solution;
(c) exposing said water wash solution to said means to separate a volatile compound component therefrom; and
(d) recovering a treated water wash solution.
(e) reusing treated water and treated volatile compounds.

5. The method according to claim 4, wherein said treated water wash solution is substantially free of volatile compound components.

6. The method according to claim 4, wherein said means to separate a volatile compound component from said water wash solution comprises at least one membrane.

7. The method according to claim 6, wherein said at least one membrane comprises a reverse osmosis membrane.

8. The method according to claim 4, wherein said water wash solution comprises one or more of the following compounds: 2-1-(2-hydroxyethyl) pyrrolidine (PR), hexamethylenediamine (HMDA), polyethylenimine (PEI, branch), 2-diethylaminoethanol (DEAE), 4-Amino-1-butanol (E), and monoethanolamine (MEA).

9. The method according to claim 5, wherein said water wash solution comprises one or more of the following compounds: 2-1-(2-hydroxyethyl) pyrrolidine (PR), hexamethylenediamine (HMDA), polyethylenimine (PEI, branch), 2-diethylaminoethanol (DEAE), 4-Amino-1-butanol (E), and monoethanolamine (MEA).

10. The method according to claim 4 wherein an initial concentration of said volatile compound component in said water wash solution is in the range of 0.01M to 0.5M.

11. The method according to claim 5 wherein an initial concentration of said volatile compound component in said water wash solution is in the range of 0.01M to 0.5M.

12. The method according to claim 4, wherein a temperature of said water wash solution is in the range of 25° C. to 40° C.

13. The method according to claim 5, wherein a temperature of said water wash solution is in the range of 25° C. to 40° C.

14. Use of an apparatus comprising a means to separate and capture a volatile compound component from a water wash solution in a water wash portion of a post-combustion carbon capture system.

15. The use according to claim 14, wherein said volatile compound component comprises one or more of the following compounds: 2-1-(2-hydroxyethyl) pyrrolidine (PR), hexamethylenediamine (HMDA), polyethylenimine (PEI, branch), 2-diethylaminoethanol (DEAE), 4-Amino-1-butanol (E), and monoethanolamine (MEA).

16. The use according to claim 15, wherein an initial concentration of said volatile compound component in said water wash solution is in the range of 0.01M to 0.5M.
